(19) United States
(12) Patent Application Publication
(10) Pub. No.: US 2008/0256732 A1
(43) Pub. Date: Oct. 23, 2008

(54) Snow brush

(76) Inventors: Anthony L. Donatelli, Rural Valley, PA (US); Anita L. Gingery, Pittsburgh, PA (US)

Correspondence Address: JAMES RAY & ASSOCIATES, 2640 PITCAIRN ROAD, MONROEVILLE, PA, 15146, US

(21) Appl. No.: 11/787,794

(22) Filed: Apr. 18, 2007

(51) Int. Cl. B25G 1/06

(52) U.S. Cl. 15/144.1

(57) ABSTRACT

An apparatus for removing snow from an exterior surface of a vehicle. The apparatus includes a brush member having bristles attached to one side of a handle portion. The brush member has a predetermined shape. A first elongated handle member is engageable at a first end thereof with a first end of the brush member. An angle adjusting mechanism is engageable at a first end thereof with a second end of the first elongated handle member and a second elongated handle member is engageable at a first end thereof with a second end of the angle adjusting mechanism.

### FIELD OF THE INVENTION

The present invention relates, in general, to a brush and, more particularly, the present invention relates to a snow brush for removing snow from the exterior of a vehicle which would enable a smaller person to still be able to remove snow from the roof of such vehicle.

### BACKGROUND OF THE INVENTION

Cleaning snow off the exterior of a car that is routinely parked outdoors is an unenviable chore. This is particularly true with new legislation that has been passed in many states. The new legislation requires that the entire car be snow free before the driver can drive the car on the highway. The new legislation will prevent what has been seen in the past where the driver will clean just a small portion of the rear window and most of the front windshield and leave the rest of the car untouched. As such a person begins to drive, snow from the roof generally is blown backwards and covers the small opening in the rear window and snow from the hood blows up and onto the windshield. Thus, the visibility of the driver is significantly impaired.

For many people, particularly those of relatively small stature, cleaning the roof portion of the car can present a problem. First, it is difficult for such people to see the roof clearly and secondly, it is difficult for such people to be able to remove the snow easily. It can even be more of a challenge cleaning the roof of larger vehicles such as trucks, vans or SUV's since it is even more difficult to see the roof portions of these vehicles even for persons with a taller stature.

### SUMMARY OF THE INVENTION

The present invention provides an apparatus for removing snow from an exterior surface of a vehicle. The apparatus includes a brush member having bristles attached to one side of a handle portion.

The brush member has a predetermined shape. A first elongated handle member is engageable at a first end thereof with a first end of the brush member. An angle adjusting means is engageable at a first end thereof with a second end of the first elongated handle member and a second elongated handle member is engageable at a first end thereof with a second end of the angle adjusting means.

### OBJECTS OF THE INVENTION

It is, therefore, one of the primary objects of the present invention to provide a snow brush that is adjustable for various heights of vehicles.

Another object of the present invention is to provide a snow brush that has an angle adjustment means for cleaning the roof of a vehicle.

Still another object of the present invention is to provide a snow brush which has a telescoping handle.

Yet another object of the present invention is to provide a snow brush which has a dual set of telescoping handles.

A further object of the present invention is to provide a snow brush that has a squeegee attached to the brush handle.

In addition to the various objects and advantages of the invention which have been described in some specific detail above it should be noted that various other objects and advantages of the present invention will become more readily apparent to those persons who are skilled in the relevant art from the following more detailed description, particularly, when such description is taken in conjunction with the appended claims.

### BRIEF DESCRIPTION OF THE DRAWINGS

FIG. 1 is a perspective view of the apparatus for removing snow from a vehicle with the handles in the extended position and with an angle adjusting means constructed in accordance with one embodiment of the invention;

FIG. 2 is a perspective view of the apparatus, shown in FIG. 1, for removing snow from a vehicle with the handles in a withdrawn or collapsed position;

FIG. 3 is a perspective view of a locking means for the angle adjusting means shown in FIGS. 1 & 2;

FIG. 4 is a perspective view of the apparatus for removing snow from a vehicle, particularly illustrating an angle adjusting means constructed in accordance with another embodiment of the invention; and

FIG. 5 is a perspective view of a locking means for the angle adjusting means shown in FIG. 4.

### DETAILED DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for removing snow from an exterior surface of a vehicle (not shown). The apparatus 10 includes a brush member, generally designated 2, having bristles 4 attached to one side of a handle portion 6. The brush member 2 has a predetermined shape. A first elongated handle member 8 is engageable at a first end thereof with a first end of the brush member 2. An angle adjusting means, generally designated 20, is engageable at a first end thereof with a second end of the first elongated handle member 8 and a second elongated handle member 12 is engageable at a first end thereof with a second end of the angle adjusting means 20.

The present invention is designed for persons who may have a difficult time looking over the roof of the vehicle (not shown) and reaching the roof to remove snow. Thus, it is presently preferred that at least one of the first elongated handle member 8 and the second elongated handle member 12 is telescoping. Preferably, each of the first elongated handle member 8 and the second elongated handle member 12 is telescoping, so that adjustments can be made in two different lengths. The second elongated member 12 can be adjusted in length so that the apparatus 10 can be long enough to reach the roof of the vehicle (not shown). The first elongated handle member 8 is designed so that the apparatus 10 can reach the width of the vehicle (not shown). Although, the second elongated handle member 12 is shown in FIG. 1 as having three telescoping portions, the present invention contemplates that any number of telescoping portions may be employed within the second elongated handle member 12 as well as within the first elongated handle member 8. The presently preferred shape of the telescopic portions is a hollow tube and, more particularly, having a round cross-section.

As can be seen in the drawing Figures, the angle adjusting means 20 is preferably disposed between the first and second elongated handle members 8, 12. This permits the user to adjust the angle after the second elongated handle member 12 is adjusted for the length necessary to reach the roof. Then, the angle adjusting means 20 is set so that the angle is such that the brush member 2 is positioned so that the bristles 4 are substantially flat against the roof of the vehicle (not shown).

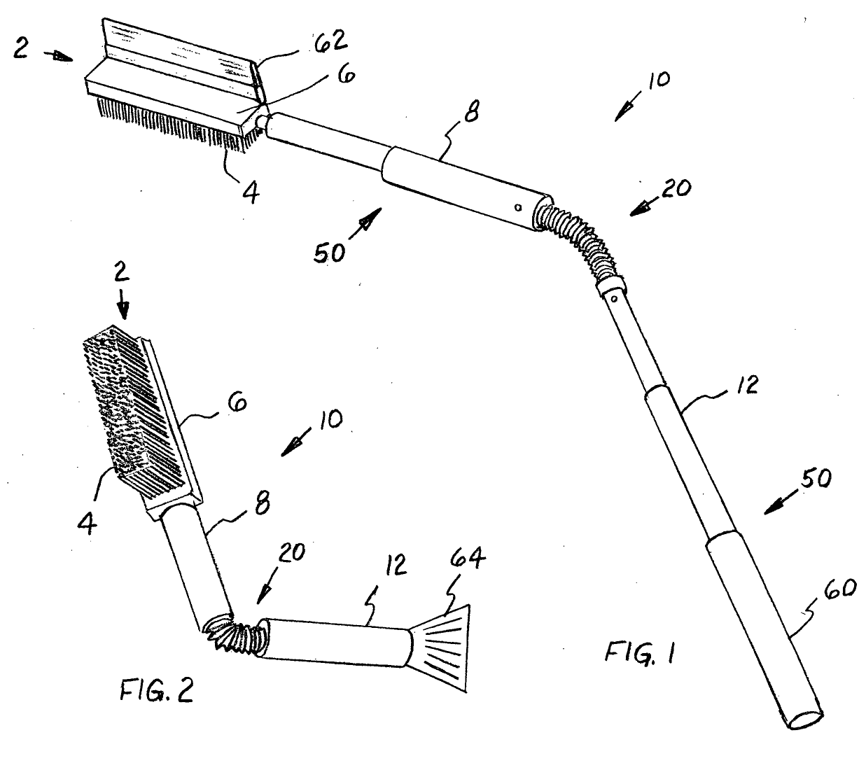

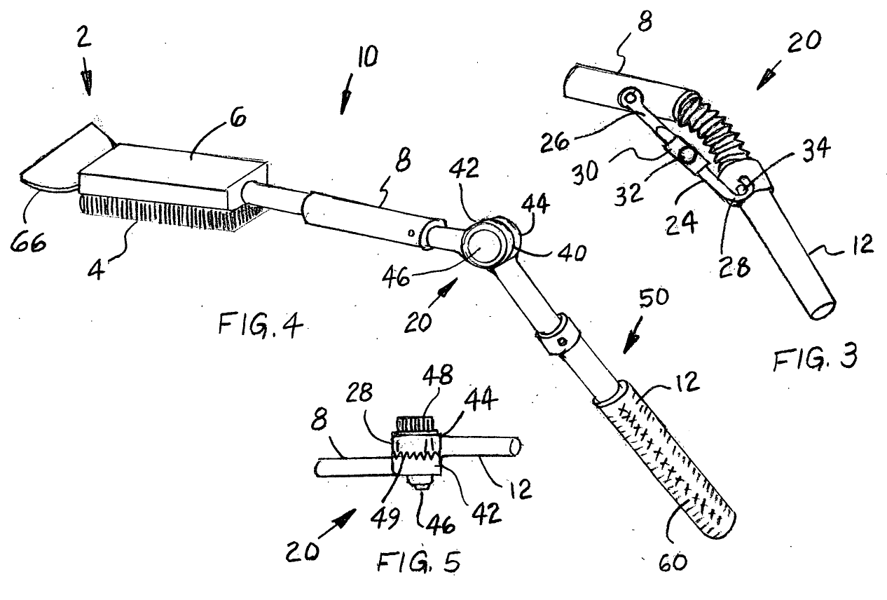

Such angle adjustment means 20 includes one of a bendable tube, a corrugated flexible tube, a pivot means, and a ratchet arrangement. When the apparatus 10 is made with a bendable tube or a corrugated flexible tube, as shown in FIGS. 1 and 2, it is presently preferred for the apparatus 10 to include means for securing the angle once it is set, otherwise when the brush member 2 is used to push against the snow, the angle may change and the brush member 2 may not be secure enough to push the snow off of the roof. By way of example in FIG. 3, the angle securing means includes a bracket member 24 for insuring that the angle set by the angle adjustment means 20 remains at whatever angle had been selected when the apparatus 10 is in use. Such bracket member 24 can be adjusted so as to secure the first elongated handle member 8 and the second elongated handle member 12 therebetween at different angles. For example, the bracket member 24 can include a first portion 26 which is pivotally secured to the first elongated handle member 8 and a second portion 28 which is mounted for linear movement relative to the first portion 26 aided by a simple hollow guide 30. A finger knob 32 which threadably engages one wall of the guide 30 is then provided for applying pressure to the first portion 26 and the second portion 28 after the predetermined angle has been set. The second portion 28 may be also pivotally connected to the second elongated handle member 12 or may be removably engageable with a pin 34 disposed on the second elongated member 12 for facilitating storage of the apparatus 10. It will be appreciated that the first portion 26 and the second portion 28 may be adapted for friction fit within the guide 30 thus eliminating the need for the knob 32.

Now in reference to FIGS. 4 and 5, there is illustrated the angle adjusting means 20 which is constructed in accordance with another embodiment of the invention. Such angle adjusting means 20 may be a simple pivot means 40 including a first pivot portion 42 which is disposed on and secured to the second end of the first elongated handle member 8, a second pivot portion 44 which is disposed on and secured to the first end of the second elongated handle member 12 and a pivot member which is received within both pivot portions 42 and 44 and which has the end 48 thereof adapted to be manually operable by the user. According to one embodiment, the pivot member is formed as a manually operable threaded fastener 46 which threadeably engages the first elongated handle member 8, as best shown in FIG. 5, but may also be adapted for threadeably engaging the second elongated handle member 12.

Therefore, the end 48 is adapted for being grasped by the user to tighten the fastener 46 thus securing the angle set by the pivot means 40. Therefore, the user simply loosens the fastener 46 in order to select the desired angle based on the height of the user and the height of the vehicle (not shown) and then manually rotates the end 48 to secure such selected angle. Furthermore, a pair of complimentary sets of serrations or teeth 49 may be provided within the pivot means 40 in a generally ratchet type arrangement for facilitating securing such set angle between the first elongated handle member 8 and the second elongated handle member 12. Thus, there is no need for a bracket or other securing means since all that is needed for the angle to be secured is a tightening of the ratchet arrangement.

According to another embodiment, the pivot member may be formed as a spring biased pin (not shown) normally biasing the first pivot portion 42 into abutment with the second pivot portion 44, particularly when the apparatus 10 is adapted with the serrations or teeth 49. Therefore, the user simply uses the end 48 to pull apart the pivoting ends of the first elongated handle member 8 and the second elongated handle member 12, selects the desired angle while the pivoting ends are pulled apart and then releases the end 48 forcing the pivoting ends into abutting relationship with each other in order to secure the selected angle.

According to yet another embodiment, the pivot means 40 may be formed as a well known ratchet of the type which is currently employed in hand tools. The end 48 will then be a well known lever which is manually operable by the user to allow pivoting of the first elongated handle member 8 and the second elongated handle member 12 in reversed directions.

At the present time, the pivot means 40, as shown in FIGS. 4 and 5, and particularly of the ratchet arrangement is a preferred method for adjusting the angle of the apparatus 10.

The telescoping of first and second elongated handle members 8, 12 includes a securing means, generally designated 50, for setting a desired length of the first elongated member 8. It is presently preferred that the securing means 50 for setting the desired length for the telescoping first and second elongated handle members 8, 12 is a friction fit which may be aided with an optional turning movement as is well known in the art for securing telescopic tubular members in the extended or collapsed positions. Apparatus 10 may be formed from metallic material, plastic material or a combination thereof and include a grip means 60 formed for, example, from an elastic material such as rubber.

As best seen in FIG. 1, the apparatus 10 may include an optional squeegee 62 that is attached to the handle portion 6 of the brush member 2. The squeegee 62 would enable the user to clean the windows of the vehicle (not shown) besides removing the snow from the vehicle (not shown). The squeegee attachment 62 is preferably disposed on the handle portion 6 on the side opposite the side with the bristles 4.

Furthermore, the apparatus 10 of the present invention may include a conventional scraper member having reference numeral 64 in FIG. 2 attached to a second end of the second elongated handle member 12 or referenced by numeral 66 in FIG. 4 attached to the brush member 2 at a second end thereof.

It will be appreciated that the squeegee 62 may be attached in a manner which is similar to attaching scraper 66.

Although the angle adjusting means 20 has been shown as a flexible bendable tube or a pivot means, it will be apparent to those skilled in the art that other means for adjusting the angle between two elongated members may be employed in the present invention.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. An apparatus for removing snow from an exterior surface of a vehicle, said apparatus comprises:
(a) a brush member having bristles attached to one side of a handle portion, said brush member having a predetermined shape;
(b) a first elongated handle member engageable at a first end thereof with a first end of said brush member;
(c) an angle adjusting means engageable at a first end thereof with a second end of said first elongated handle member; and
(d) a second elongated handle member engageable at a first end thereof with a second end of said angle adjusting means.

2. The apparatus, according to claim 1, wherein said first elongated handle member includes a plurality of telescoping portions for adjustment to various lengths.

3. The apparatus, according to claim 2, wherein said first elongated handle member further includes a securing means for setting a desired length thereof.

4. The apparatus, according to claim 3, wherein said securing means is a friction fit.

5. The apparatus, according to claim 1, wherein said second elongated handle member includes a plurality of telescoping portions for adjustment to various lengths.

6. The apparatus, according to claim 5, wherein said second elongated handle member further includes a securing means for setting a desired length thereof.

7. The apparatus, according to claim 6, wherein said securing means is a friction fit.

8. The apparatus, according to claim 1, wherein said angle adjustment means includes one of a bendable tube, a pivot means, a ratchet arrangement and a corrugated flexible tube.

9. The apparatus, according to claim 8, wherein said angle adjustment means is said corrugated flexible tube.

10. The apparatus, according to claim 9, wherein said angle adjustment means further includes a bracket member for insuring that said angle adjustment means remains at whatever angle has been selected when said apparatus is in use.

11. The apparatus, according to claim 10, wherein said bracket member includes a first portion which is pivotally secured to said first elongated handle member, a second portion which is engageable with said second elongated handle member and which is mounted for linear movement relative to said first portion, and a hollow guide for guiding said linear movement.

12. The apparatus, according to claim 11, wherein said bracket member further includes a fastener which threadably engages one wall of said hollow guide and which is manually operable for applying pressure to said first portion and said second portion after said angle has been selected.

13. The apparatus, according to claim 8, wherein said angle adjustment means is said pivot means having a first pivot portion which is disposed on and secured to said second end of said first elongated handle member, a second pivot portion which is disposed on and secured to said first end of said second elongated handle member, and a pivot member which is operably received within both pivot portions.

14. The apparatus, according to claim 13, wherein said pivot means includes a manually operable fastener which is tightened to insure that said angle adjustment means remains at whatever angle has been selected when said apparatus is in use.

15. The apparatus, according to claim 13, wherein said pivot means further includes a pair of complimentary sets of at least one of serrations and teeth.

16. The apparatus, according to claim 13, wherein said pivot means includes a pin and a spring which biases said first pivot portion and said second pivot portion into abutting relationship with each other.

17. The apparatus, according to claim 8, wherein said angle adjustment means is said ratchet arrangement having a manually operable member for allowing pivoting of said first elongated handle member and said second elongated handle member in reversed directions.

18. The apparatus, according to claim 1, wherein said apparatus further includes a squeegee attachment which is attached to said handle portion of said brush member.

19. The apparatus, according to claim 18, wherein said squeegee attachment is disposed on said handle portion on a side opposite said side with said bristles.

20. The apparatus, according to claim 1, wherein said apparatus further includes a scraper member which is attached to one of said brush member and said second elongated-handle member.
